(19) United States
(12) Patent Application Publication
(10) Pub. No.: US 2014/0322488 A1
(43) Pub. Date: Oct. 30, 2014

(54) CREPED PAPERBOARD

(71) Applicant: KIMBERLY-CLARK WORLDWIDE, INC., Neenah, WI (US)

(72) Inventor: Maurizio Tirimacco, Appleton, WI (US)

(73) Assignee: Kimberly-Clark Worldwide, Inc., Neenah, WI (US)

(21) Appl. No.: 13/874,005

(22) Filed: Apr. 30, 2013

(51) Int. Cl. B32B 29/00; B32B 38/00; D21H 25/00

(52) U.S. Cl. CPC B32B 29/005; D21H 1/04; D21H 25/005; B32B 38/0012
USPC 428/153; 156/220

(57) ABSTRACT

Disclosed are creped paperboard structures prepared by treating one side of a paperboard web having a basis weight greater than about 100 grams per square meter (gsm) with a bonding material and creping the paperboard web. The creped paperboard webs have physical properties comparable to traditional corrugated structures, but use less material and are easier to manufacture.

### BACKGROUND

Conventional methods and corrugated structures have been used to form a variety of corrugated packages. Conventional corrugated structures typically include a base material, an intermediate flute and a liner material. The intermediate flute secures the liner to the base material.

Conventional containers formed from conventional corrugated structures include paper plates, bowls, clamshells, trays and other disposable products. The containers are formed from a corrugated structure blank. The containers typically have three layers or plies. The first layer contacts the food or product placed on the container. The middle layer is a corrugated flute and secures the first layer to the third layer. The third layer forms the support base for the container. The blank is formed or shaped into the container using a conventional technique, such as thermoforming.

However, the above conventional containers are not suitable for all applications, require three separate materials and can be costly to produce. Accordingly, there is a need for improved structures that allow for flexible manufacturing techniques and practices, and for improved structures which exhibit substantial reduction in the amount of materials used without a decrease in functional performance.

### SUMMARY

Surprisingly, creped paperboard structures may be prepared by treating one side of a paperboard web having a basis weight greater than about 100 grams per square meter (gsm) with a bonding material and creping the paperboard web. After one side of the paperboard web is treated with a bonding material and creped from a creping surface at least one side of the web takes on a texture. In this manner a creped paperboard web may be produced having one side that is structurally similar to traditional fluting used in the production of corrugated structures. Rather than use two separate webs to create the corrugated structure, however, the instant invention provides a similar structure using only a single paperboard web. Thus, the present invention conserves materials, simplifies manufacturing and offers unique product attributes compared to corrugated structures of the prior art.

Accordingly, in one embodiment the present disclosure provides a creped paperboard web comprising a first side and a second side, a bonding material disposed on at least the first side, wherein the creped paperboard web has a basis weight greater than about 100 grams per square meter (gsm) and a Burst Strength greater than about 50 pounds per square inch (psi).

In yet other embodiments the present disclosure provides a creped paperboard web comprising a first side, a second side and a self-crosslinking ethylenevinylacetate latex binder disposed on the first side, the first side having been adhered to and creped from a drum dryer, wherein the creped paperboard web has a basis weight greater than about 100 gsm and a Burst Strength greater than about 50 psi.

Depending on the desired result the bonding material may be applied only to one side of the web or to both sides of the web. In either case, only one side of the web is creped. Various patterns may be used to apply the bonding material to the paperboard web. The pattern may comprise a grid or, alternatively, a succession of discrete shapes. Once applied to the paperboard web, the bonding material may cover from about 10 to about 50 percent of the surface area of one side of the web.

Regardless of whether the bonding material is applied to one or both sides of the web, the creped paperboard web has two opposing surfaces, or sides, at least one of which is textured. Accordingly, in one embodiment the present disclosure provides a creped paperboard web having a first and a second side wherein the surface texture of the first and second sides is different. In one particularly preferred embodiment the first side of the web is textured and the second side is substantially smooth. For instance, in one embodiment, the first side of the creped paperboard web has a Surface Root Mean Square Roughness (Sq) greater than about 60 μm and the second side has a Surface Root Mean Square Roughness (Sq) less than about 40 μm.

In another embodiment the present disclosure provides a creped paperboard web comprising opposing first and second sides, a bonding material disposed on at least one of the sides, and at least one of the sides having a Surface Root Mean Square Roughness (Sq) greater than about 60 μm, and more preferably greater than about 80 μm, wherein the web has a basis weight greater than about 100 gsm and a Burst Strength greater than about 50 psi.

In still other embodiments the present disclosure provides a method of forming a creped paperboard web comprising the steps of providing a paperboard web having a basis weight of at least about 100 gsm, applying a bonding material to at least one side of the paperboard web, pressing the paperboard web against the surface of drying drum and creping the paperboard web from the dryer drum.

The products and processes are particularly well suited to forming a single ply structure, however, multi-ply structures comprising one or more creped paperboard webs are within the scope of the present invention. For example, in one embodiment the present invention provides a structure comprising a first creped paperboard web and a linerboard web adhesively bound to one another.

In still another embodiment the present disclosure provides a paperboard structure comprising a first ply and a second ply, wherein the first ply comprises a linerboard having a basis weight from about 100 to about 300 gsm and the second ply comprises a creped paperboard web having a basis weight from about 100 to about 300 gsm, wherein the paperboard structure has a Burst Strength greater than about 125 psi.

### BRIEF DESCRIPTION OF THE DRAWINGS

FIG. 1 is a schematic diagram of one embodiment of a process for applying a bonding material to one side of a paperboard web and creping the web in accordance with the present invention;

FIG. 2 illustrates one embodiment of a creped paperboard according to the present invention;

FIG. 3 illustrates a two ply structure comprising a creped paperboard according to the present invention and a linerboard;

FIG. 4 illustrates a three ply structure comprising two creped paperboard plies and a linerboard ply; and

FIG. 5 illustrates a four ply structure comprising three creped paperboard plies and a linerboard ply.

### DEFINITIONS

As used herein the term “paperboard” refers to a fibrous web having a basis weight greater than about 100 grams per square meter (gsm) and a bulk less than about 3 cm³/g.

As used herein the term “linerboard” refers to a substantially flat fibrous web having a basis weight greater than about 100 grams per square meter (gsm) and a bulk less than about 3 cm³/g.

As used herein the term “Burst Strength” refers to the force required to rupture a paperboard web as measured according to TAPPI test method 810 om-11 and described in the test methods section below. Burst Strength is generally reported as pounds per square inch (psi).

As used herein the terms “caliper” and “thickness” generally refer to the thickness of the web measured as the perpendicular distance between two circular plane parallel surfaces under a pressure of 1 kg/cm² using a micrometer. Caliper is generally reported as millimeters (mm) or mils.

As used herein the term “basis weight” refers to the bone dry basis weight measured according to TAPPI T 410. Basis weight is generally reported as either gsm or lbs/1000 ft².

### DETAILED DESCRIPTION

In general, the present invention is directed to a creped paperboard and process for making the same. The process for making creped paperboard comprises coating at least one surface of a paperboard web with a bonding material, and more preferably a latex binder, and still more preferably a self-crosslinking ethylenevinylacetate latex binder, contacting the coated surface with a heated dryer surface and creping the web from the dryer. The linerboard thus treated is sufficiently flexible to be formable into conventional rolls for subsequent processing or storage, of having enhanced strength, and of being formable into corrugated paperboard structures having enhanced strength. The board may be fabricated on conventional tissue creping machinery employing conventional techniques of fabrication and conventional commercial speeds. Subsequent formation of carton blanks and cartons may also be accomplished employing standard machinery and techniques.

Generally at least one surface of the creped paperboard web is highly textured. When using a creped paperboard web having one highly textured side, various other benefits and advantages are realized. For instance, the paperboard web may possess opposite sides with very different characteristics. For example, in one particularly preferred embodiment, one side of the paperboard web is substantially smooth while the opposing side is highly textured. The two-sided properties of the paperboard web provide various advantages and benefits. For example, the untreated, textured side of the web may serve as the surface for contacting and protecting shipped goods, while the smooth side of the web, on the other hand, may be better suited for printing and handling.

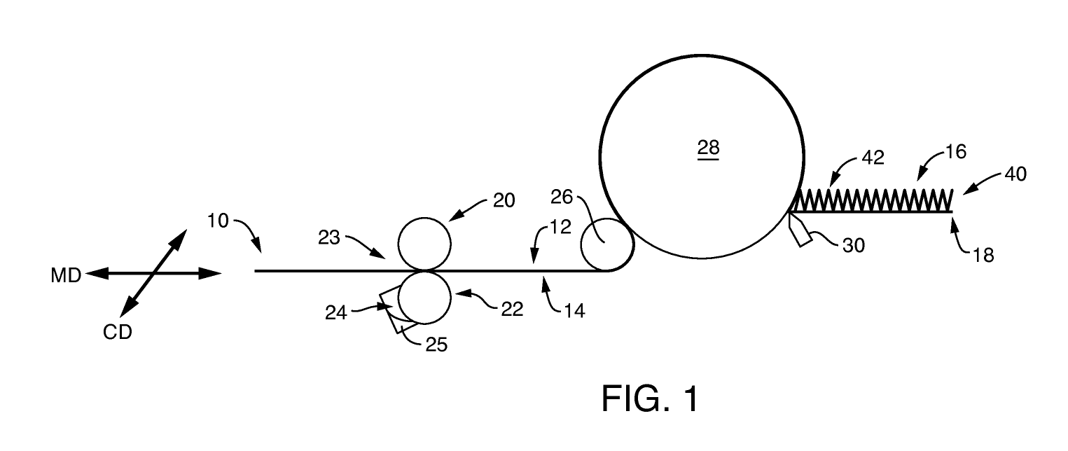

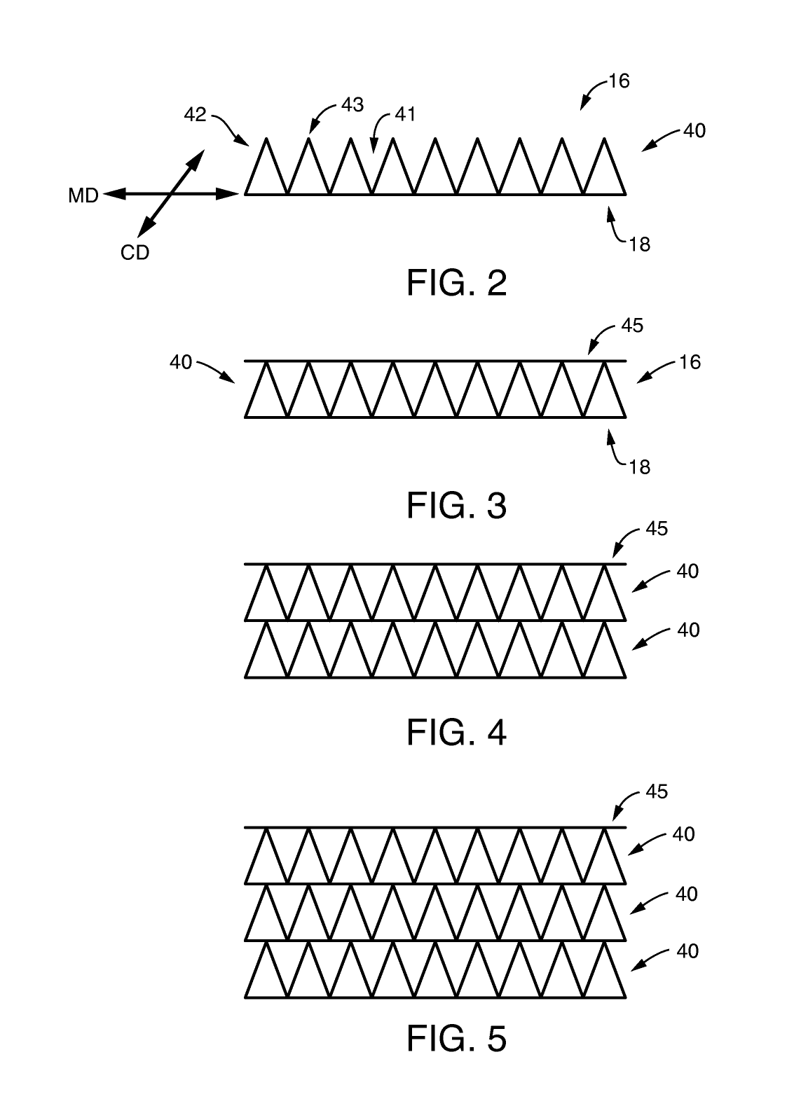

In one particularly preferred embodiment, such as that illustrated in FIG. 1, the present invention provides a creped paperboard web 40 having a latex binder 25 disposed on at least one surface 14. The latex coated surface 14 is preferably pressed against a Yankee dryer 28 and creped therefrom by a creping blade 30 resulting in the dryer contacting surface 18 (also referred to as the creped surface or the surface contacting the creping blade) having a substantially smooth surface and the opposite surface 16 having a plurality of undulations 42, also referred to as crepe folds. In this manner the latex threated surface is substantially smooth while the opposite surface is provided with a plurality of undulations 42, which are illustrated in detail in FIG. 2 as alternating peaks 43 and valleys 41 which extend in parallel fashion from edge to edge of the creped web 40. Peaks 43 provide the creped web 40 with a plurality of upper presented surface 16.

Generally the creped web has a machine (MD) and a cross-machine (CD) direction. As illustrated in FIG. 2 the alternating peaks 43 and valleys 41 are generally oriented in the MD direction. The peaks 43 and valleys 41 generally define crepe bars that are substantially oriented in the CD direction and extend from one edge of the creped web 40 to other. The peaks 43 and valleys 41 are illustrated as being substantially regular and uniform, however, in practice the size, spacing and orientation of the peaks 43 and valleys 41 may vary.

Preferably, the creped web comprises a medium weight paper product having a basis weight greater than about 100 grams per square meter (gsm), such as from about 100 to about 500 gsm and more preferably from about to about 120 to about 250 gsm. Paper products falling within these basis weights are commonly used in the construction of packaging materials and are well known in the art. Generally, the paperboard web is a fibrous web formed on a fourdrineir machine utilizing one or more headboxes and having a basis weight greater than about 100 gsm, such as from about 100 to about 500 gsm, a caliper greater than about 0.20 millimeters and a Burst Strength greater than about 50 psi. A particularly preferred paperboard is kraft paperboard, which is paperboard made from pulp produced by the kraft process, having a basis weight of greater than about 100 gsm. More preferably the paperboard comprises a kraft paperboard having a basis weight of about 127, 161 or about 186 gsm (26, 33 or 38 lb/1000 ft²) and a caliper from about 0.20 to about 0.65 millimeters.

As noted previously the invention generally provides a creped paperboard having at least one surface that is highly textured. In certain embodiments, one surface may be highly textured while the opposing surface is substantially smooth. In other embodiments both surfaces of the creped paperboard web may be textured, with the opposing sides having differing amounts of texture.

The topographical features of a paperboard web surface, i.e., surface texture, can be characterized or expressed quantitatively by any number of ways known to those skilled in the art using non-contact optical profilometry techniques. As an example, the texture of both the dryer contacting and air side of the creped paperboard webs may be measured using non-contact optical profilometry techniques to create a three-dimensional representation of the surfaces as explained in further detail below. From the three-dimensional representations roughness parameters Sa (Surface Average Roughness) and Sq (Surface Root Mean Square Roughness) may be calculated and used to quantify the texture of either side of the creped paperboard web.

Accordingly, surface profilometry may be used to characterize the creped paperboard web, which generally consists of crepe bars extending in the CD and alternating peaks and valleys extending in the MD. In these embodiments, the web generally has from about 4 to about 50 peaks per inch extending in the MD with from about 8 to about 25 ridges per inch extending in the MD being particularly preferred. The structure includes crepe bars, that is, the web may have from about 4 to about 50 ridges per inch extending in the machine direction and from about 10 to about 150 crepe bars per inch extending in the cross-machine direction of the web.

In one particularly preferred embodiment the creped paperboard web has a substantially smooth first side, such as an Sq less than about 40 μm, and more preferably less than about 30 μm and an Sa less than about 30 μm, and more preferably less than about 20 μm, and an opposing textured second side having an Sq greater than about 60 μm, and more preferably greater than about 80 μm, and an Sa greater than about 50 μm, and more preferably greater than about 60 μm. In other embodiments there may simply be a difference in the texture of one side versus the other. For example, the difference in Sq between the first and second side of the creped paperboard web may be greater than about 10 percent and more preferably greater than about 20 percent, such as from about 20 to about 30 percent. More preferably the difference in Sa between the two sides of the web is from about 10 to about 40 percent and more preferably from about 15 to about 30 percent.

In addition to displaying two-sided surface characteristics where one side is substantially smooth and the other is textured, in other embodiments the present invention provides for a creped paperboard web where both surfaces are textured. Without being bound by theory, it is believed that in certain instances where the paperboard is a single layer paperboard or multilayered paperboard having a high degree of intra-layer bonding, creping of the paperboard does not result in delamination of one of the layers yielding a textured and a smooth layer. Instead, creping causes both sides of the web to have a textured surface. In this manner the interlayer strength may be optimized using techniques known in the art to yield a creped paperboard having differing degrees of texture on its opposing sides and more particularly to yield a creped paperboard having a substantially smooth side and a textured side.

Accordingly, in certain embodiments the invention provides a creped paperboard having a first textured creped side (generally the dryer contacting surface or the surface that has been contacted by the contacting blade) and a second textured uncreped side (generally the non-dryer contacting surface) where the Sq of the first side is greater than about 60 μm, and more preferably greater than about 80 μm, such as from about 80 to about 110 μm and an Sa greater than about 50 μm, and more preferably greater than about 60 μm, such as from about 60 to about 90 μm. The second side on the other hand has an Sq greater than about 50 μm, and more preferably greater than about 70 μm, and an Sa greater than about 40 μm, and more preferably greater than about 50 μm.

Not only do the inventive webs have at least one textured surface, which may mimic the flutes of conventional corrugated structures, but the inventive webs also have strength properties that are comparable to conventional corrugated structures. For example, the creped paperboard webs of the present invention preferably have Burst Strengths greater than about 50 psi, such as from about 50 to about 150 psi and more preferably from about 60 to about 100 psi. Further the creped paperboard webs have MD Tensile Strengths greater than about 20 pounds per inch (lbs/in), such as from about 20 to about 50 lbs/in and more preferably from about 30 to about 50 lbs/in.

Generally, paperboard webs useful in the present invention may be prepared using methods well known in the art. For example, a paperboard web may be formed by first forming a wet fibrous mat from a supply of pulp fibers from an aqueous slurry in a well-known manner. Most fibers are cellulose fibers, which can be provided from secondary materials, virgin fibers, or a combination of both, as is well known in the art. In one embodiment, the wet mat includes more than 60 wt % of cellulose fibers. In an alternate embodiment, the wet mat includes more than 10 wt % of cellulose fibers. Additives may be added in the pulp to modify the appearance and/or physical characteristics of the paperboard produced. Many types of additives are well known in the art, examples of such well known additives are mineral fillers (or inorganic fillers), dry strength resins, retention and drainage aids (chemicals), sizing agents, etc.

The wet mat can have a plurality of plies of superposed pulp-based material. In one embodiment, the paperboard has between one and five plies of pulp-based material. Preferably the paperboard web comprises two plies and has a basis weight greater than about 100 gsm, such as from about 100 to about 300 gsm and more preferably from about 120 to about 270 gsm. It is appreciated that the composition of each ply can vary. For example, in an embodiment, the outer plies, also referred to as liners, can have a first composition in pulp fiber while the inner plies, also referred to as fillers, can have a second pulp fiber composition.

After formation the wet mat is then drained to allow water to drain by means of a force such as gravity or a pressure difference. The wet mat is further partially dewatered in a press unit, using press rolls, where the wet mat is squeezed, to obtain a wet mat having between about 20 wt % to about 70 wt % solids with an acceptable thickness and smoothness, as is known in the art.

The pressed mat is then dried by passing the mat through a drying unit having multiple drying rolls to obtain the paperboard web. The drying rolls can be heated and the wet mat is dried through contact with the rolls or the dryer can have blowers which generate warm air currents within the dryer. For instance, without being limitative, other drying systems can be used to dry the wet embossed mat such as drum dryers, filled with steam, infrared dryers, air dryers, evaporation tables, ovens (forced convection drying), dryer felts, etc.

The paperboard web, once dried, has a thickness ranging between about 0.20 and 0.60 millimeters and a basis weight greater than about 100 gsm, such as from about 100 to about 300 gsm and more preferably from about 120 to about 270 gsm. The basis weight refers to the bone dry basis weight of the paperboard web.

Once the paperboard web is formed, a bonding material is applied to at least one side of the web and the treated side of the web is then creped. Referring to FIG. 1, one embodiment of a system that may be used to apply bonding materials to the paperboard web and to crepe one side of the web is illustrated. In the process shown in FIG. 1, the bonding materials are applied to only one side of the paperboard web, however it should be understood that in other embodiments both sides of the paperboard web may be treated with a bonding material. The embodiment shown in FIG. 1 can be an in-line or off-line process. As shown, paperboard web 10 is passed through a first bonding agent application station generally 23. Station 23 includes a nip formed by a smooth rubber press roll 20 and a patterned rotogravure roll 22. Rotogravure roll 22 is in communication with a reservoir 24 containing a first bonding material 25. Rotogravure roll 22 applies the bonding material 25 to one side of the web 10 in a preselected pattern.

Web 10 may then be contacted with a heated roll (not illustrated). The heated roll is for partially drying the web. The heated roll can be heated to a temperature, for instance, up to about 250° F. and particularly from about 200° F. to about 220° F. In general, the web can be heated to a temperature sufficient to dry the web and evaporate any water.

It should be understood, that besides the heated roll, any suitable heating device can be used to dry the web. For example, in an alternative embodiment, the web can be placed in communication with an infra-red heater in order to dry the web. Besides using a heated roll or an infra-red heater, other heating devices can include, for instance, any suitable convective oven or microwave oven.

Once the bonding material is applied, web 10 is adhered to a creping roll 28 by a press roll 26. Web 10 is carried on the surface of the creping drum 28 for a distance and then removed therefrom by the action of a creping blade 30. The creping blade 30 performs a controlled pattern creping operation on the first side of the paperboard web.

Once creped the paperboard web 10 may be pulled through a drying station (not illustrated). The drying station can include any form of a heating unit, such as an oven energized by infrared heat, microwave energy, hot air, or the like. A drying station may be necessary in some applications to dry the web and/or cure the bonding materials. Depending upon the bonding materials selected, however, in other applications a drying station may not be needed.

The amount that the paperboard web is heated within the drying station can depend upon the particular bonding materials used, the amount of bonding materials applied to the web, and the type of web used. In some applications, for instance, the paperboard web can be heated using a gas stream such as air at a temperature of about 510° F. in order to cure the bonding materials.

The bonding materials applied to the paperboard web are selected for not only assisting in creping the web but also for adding dry strength, wet strength, stretchability, and tear resistance to the paperboard web. Particular bonding materials that may be used in the present invention include latex compositions, such as carboxylated vinyl acetate-ethylene terpolymers, acrylates, vinyl acetates, vinyl chlorides and methacrylates. Some water-soluble bonding materials may also be used including polyacrylamides, polyvinyl alcohols and cellulose derivatives such as carboxymethyl cellulose. Other bonding materials include styrene-butadiene copolymers, polyvinyl acetate polymers, vinyl-acetate ethylene copolymers, vinyl-acetate acrylic copolymers, ethylene-vinyl chloride copolymers, ethylene-vinyl chloride-vinyl acetate terpolymers, acrylic polyvinyl chloride polymers, nitrile polymers, and the like. Other examples of suitable latex polymers may be described in U.S. Pat. No. 3,204,810 to Meisel, which is incorporated herein by reference in a manner consistent with the present invention.

In one embodiment, the bonding materials used in the process of the present invention comprise an ethylene vinyl acetate copolymer. In particular, the ethylene vinyl acetate copolymer can be cross-linked with N-methyl acrylamide groups using an acid catalyst. Suitable acid catalysts include ammonium chloride, citric acid and maleic acid.

The bonding materials are applied to the base web as described above in a preselected pattern. In one embodiment, for instance, the bonding materials can be applied to the web in a reticular pattern, such that the pattern is interconnected forming a net-like design or grid on the surface. In an alternative embodiment, however, the bonding materials are applied to the web in a pattern that represents a succession of discrete shapes. Applying the bonding material in discrete shapes, such as dots, provides sufficient strength to the web without covering a substantial portion of the surface area of the web.

According to the present invention, the bonding materials are applied to at least one side of the paperboard web so as to cover from about 15 to about 75 percent of the surface area of the web. More particularly, in most applications, the bonding material will cover from about 20 to about 60 percent of the surface area of each side of the web. The total amount of bonding material applied to each side of the web can be in the range of from about 1 to about 25 percent by weight, such as from about 2 to about 10 percent by weight, based upon the total weight of the web.

At the above amounts, the bonding materials generally do not penetrate deep below the surface of the paperboard web. Accordingly, in a preferred embodiment the bonding materials penetrate from about 5 to about 15 percent of the total thickness of the web.

The process that is used to apply the bonding materials to the paperboard web in accordance with the present invention can vary. For example, various printing methods can be used to print the bonding materials onto one or both sides of the paperboard web depending upon the particular application. Such printing methods can include direct gravure printing using two separate gravures for each side, offset gravure printing using duplex printing (both sides printed simultaneously) or station-to-station printing (consecutive printing of each side in one pass). In another embodiment, a combination of offset and direct gravure printing can be used. In still another embodiment, flexographic printing using either duplex or station-to-station printing can also be utilized to apply the bonding materials.

According to the process of the current invention, numerous and different corrugated-like products can be formed. For instance, in one embodiment a single ply paperboard structure may be formed having one substantially smooth side and a textured side. The textured side of the web may function in a manner similar to fluting in traditional corrugated structures. The basis weight of single ply structures can range anywhere from about 100 and about 300 gsm and more preferably from about 120 to about 270 gsm and still more preferably from about 150 to about 250 gsm. In one particular embodiment, the present invention is directed to the production of a single ply creped paperboard having a basis weight of from about 120 to about 250 gsm, the creped paperboard having a first side having an Sq greater than about 60 μm, and more preferably greater than about 80 μm, and a second side having an Sq less than about 40 μm, and more preferably greater than about 30 μm.

In an alternative embodiment, paperboard webs made according to the present invention can be incorporated into multiple ply products. For instance, in one embodiment, a paperboard web made according to the present invention can be attached to one or more other paperboard webs for forming a multi-ply structure having desired characteristics. The various creped paperboard layers may incorporate one or more uncreped paperboard layers, also referred to herein as linerboard. For example, as illustrated in FIGS. 3-5, the multi-ply paperboard structure may comprise one, two or three creped paperboard webs 40 and a liner board layer 45. The two ply structure illustrated in FIG. 3 comprises a creped paperboard web 40 and a liner board layer 45 adhered to the textured surface 16 of the creped paperboard web 40. In other embodiments, such as illustrated in FIGS. 4 and 5, two or more creped paperboard webs 40 may be adhered to one another with a liner board liner 45 adhered to the upper most creped paperboard web 40.

In the composite structures illustrated in FIGS. 3-5, the planar sheet of material is preferably a sheet of linerboard having flexibility, or stiffness as measured by the Corrugated Linerboard Test (CLT), normally accepted in the industry for use in single faced and double faced corrugated board applications. Preferably, first facing linerboard liner 45 is made of kraft linerboard, and may be used in a variety of strengths and basis weights.

The structure illustrated in FIG. 3 is prepared by adhering the creped paperboard 40 to the first facing linerboard liner 45. Typically, an adhesive, such as a starch based glue, will be applied to the upper peaks 43 of the creped paperboard 40, and first facing linerboard liner 45 will be pressed thereon. In this manner, first facing 45 is affixed to creped paperboard 40 along the upper peaks 43. Thus, the upper peaks 43 are prevented from distorting or flattening out.

The resulting composite structure preferably has a high resistance to stretching or tearing due to tensile forces exerted thereon, being, for example, equal to or greater than that of the material from which the first facing is made, but which has little, if any, capacity to withstand or transmit any compressive forces exerted across spanning lengths of the material.

In a particularly preferred embodiment composite structures, such as those illustrated in FIGS. 3-5 are manufactured using techniques currently employed in the industry for single faced and double faced corrugated board. Briefly, creped paperboard is stripped from a roll, run through a series of tension rollers, and passed through a glue station wherein the appropriate adhesive is applied to upper presented surfaces. At the same time, linerboard is stripped from a roll of the film, run past a series of tension rollers, and brought into contact with the upper presented surfaces of the creped paperboard after the creped paperboard has passed through the gluing station. The combined sheet is then passed through a series of nip and laminating rollers, whereby the film is firmly pressed onto the single faced sheet.

The combined sheet then passes to a rewind station where it is rolled.

### Test Methods

Surface Roughness

Surface roughness was measured by first generating a digital image of the sample surface using an FRT MicroSpy® Profile profilometer (FRT of America, LLC, San Jose, Calif.) and then analyzing the image using Nanovea® Ultra software version 6.2 (Nanovea Inc., Irvine, Calif.). Samples (either base sheet or finished product) were cut into squares measuring 145×145 mm. The samples were then secured to the x-y stage of the profilometer using tape, with either the creped or uncreped surface of the paperboard sample facing upwards, being sure that the samples were laid flat on the stage and not distorted within the profilometer field of view.

Once the sample was secured to the stage the profilometer was used to generate a three dimension height map of the sample surface. A 1602×1602 array of height values were obtained with a 30 μm spacing resulting in a 48 mm MD×48 mm CD field of view having a vertical resolution of 100 nm and a lateral resolution of 6 μm. The resulting height map was exported to .sdf (surface data file) format.

Individual sample .sdf files were analyzed using Nanovea® Ultra version 6.2 by performing the following functions:

(1) Using the “Thresholding” function of the Nanovea® Ultra software the raw image (also referred to as the field) is subjected to thresholding by setting the material ratio values at 0.5 to 99.5 percent such that thresholding truncates the measured heights to between the 0.5 percentile height and the 99.5 percentile height;

(2) Using the “Fill In Non-Measured Points” function of the Nanovea® Ultra software the non-measured points are filled by a smooth shape calculated from neighboring points;

(3) Using “Filtering>Wavyness+Roughness” function of the Nanovea® Ultra software the field is spatially low pass filtered (waviness) by applying a Robust Gaussian Filter with a cutoff wavelength of 0.095 mm and selecting “manage end effects”;

(4) Using the “Filtering−Wavyness+Roughness” function of the Nanovea® Ultra software the field is spatially high pass filtered (roughness) using a Robust Gaussian Filter with a cutoff wavelength of 0.5 mm and selecting “manage end effects”; and

(5) Using the “Parameter Tables” study function of the Nanovea® Ultra software ISO 25178 Values Sq (root mean square height, expressed in units of mm) and Sa (arithmetic mean height, expressed in units of mm) are calculated and reported.

Based upon the foregoing, two values, indicative of surface roughness are reported (Sq and Sa) which all have units of mm. The units have been converted to microns for use herein.

### Burst Strength

Burst Strength is the measure of the force required to rupture the paperboard web or structures prepared therefrom. Burst Strength was measured according to TAPPI test method 810 om-11. Clamping gage pressure was adjusted to 100 psi. Burst Strength was determined for both sides of the sample and reported as the average determined from the analysis of ten (10) samples.

### Tensile Strength

Tensile was determined using TAPPI test method T 494 om-06. The test method measured both tensile strength and stretch. Gage length was set at two (2) inches, speed was set at 0.50 inches/minute and the test was run for 0.2 inches. All tensile measurements are reported as the average determined from the analysis of twelve (12) samples. For creped paperboard samples the samples were orientated such that the machine direction (MD) was perpendicular to the crepe folds and the cross-machine direction (CD) was parallel to the crepe folds. For linerboard and corrugated structures the cross-machine direction (CD) was parallel to corrugate.

### EXAMPLES

A pilot machine was used to produce a creped paperboard structure in accordance with this invention generally as described in FIG. 1. Creped paperboard structures were prepared from two different standard kraft paperboards, the first having a basis weight of 26 pounds (130 g/m²) and the second having a basis weight of 33 pounds (161 g/m²). A latex binder was applied to the first side (Yankee contact surface) of the paperboard using a diamond gravure roll pattern. The latex binder was a vinyl acetate/ethylene copolymer dispersions sold under the tradename VINNAPAS® EP1133 (Wacker Chemical Corp., Allentown, Pa.). The details of the latex application step are set forth in Table 1. Control samples were uncreped. Inventive samples were creped by pressing the latex printed linerboard against a rotating Yankee dryer, which had a surface temperature of 200° F., and then creping the board from the surface.

TABLE 1

| | BW | Latex | Line Speed | |
|---|---|---|---|---|
| Sample | (lbs/1000 ft²) | Percent Solids | (fpm) | Crepe Ratio |
| Control 1 | 26 | 40% | 200 | NA |
| Control 2 | 26 | 50% | 230 | NA |
| 6 | 26 | 50% | 230 | 1.12 |
| 7 | 26 | 50% | 230 | 1.36 |
| 8 | 33 | 50% | 230 | 1.12 |

The resulting creped paperboard samples had a textured surface on both the creped and uncreped surfaces of the web, with the uncreped surface having more texture. A three ply structure (referred to as the inventive fluted structures) was prepared from the creped linerboard samples by gluing uncreped linerboard to the top and bottom surfaces of the creped linerboard sample prepared as described in Table 2. The plies were glued together using VINNAPAS® EP1133 (Wacker Chemical Corp., Allentown, Pa.).

TABLE 2

| | | Uncreped Linerboard |
|---|---|---|
| | Creped Linerboard | Basis Weight |
| Sample | Sample | (lbs/1000 ft²) |
| 11 | 6 | 26 |
| 12 | 7 | 26 |
| 13 | 8 | 33 |

The inventive creped linerboard and fluted structures were subjected to physical testing as described above. The results of the physical testing are summarized in Tables 3 and 4. For comparison, commercially available corrugated structures were also tested and reported in the tables below.

TABLE 3

| | | | Burst | Burst |
|---|---|---|---|---|
| | Caliper | Basis Weight | Side A | Side B |
| Sample | (mils) | (g/m2) | (psi) | (psi) |
| 11 | 33.5 | 471 | 174 | 167 |
| 12 | 53.4 | 532 | 147 | 147 |
| 13 | 47.3 | 592 | 216 | 154 |
| E-Flute | 63.1 | 445 | 167 | 154 |
| B-Flute | 175 | — | 242 | 250 |
| C-Flute | 166 | — | 245 | 225 |

TABLE 4

| | | MD | MD | CD | CD | Burst | Burst |
|---|---|---|---|---|---|---|---|
| | | Tensile | Stretch | Tensile | Stretch | Side A | Side B |
| Sample | Description | (lbf/in) | (%) | (lbf/in) | (%) | (psi) | (psi) |
| Control 3 | 26 lb uncreped, | 51.9 | 1.69 | 27.7 | 3.60 | 78.4 | 75.4 |
| | no latex | | | | | | |
| Control 4 | 33 lb uncreped, | 58.3 | 1.58 | 37.3 | 3.56 | 89.6 | 89.4 |
| | no latex | | | | | | |
| Control 1 | 26 lb uncreped, | 53.8 | 1.99 | 27.0 | 3.69 | 76.7 | 75.9 |
| | latex | | | | | | |
| Control 2 | 26 lb uncreped, latex | 52.0 | 1.62 | 27.3 | 3.90 | 75.4 | 67.0 |
| 6 | 26 lb, latex, | 30.7 | 13.3 | 18.3 | 3.36 | 69.4 | 68.6 |
| | 1.12 crepe ratio | | | | | | |
| 7 | 26 lb, latex, | 19.7 | 41.7 | 23.2 | 3.56 | 55.8 | 55.8 |
| | 1.36 crepe ratio | | | | | | |

From the above it can be seen that a creped paperboard web can be prepared having attributes comparable to traditional corrugated structures. While in the above example creping reduced tensile strength, creping did not significantly reduce burst strength. Moreover, when a composite structure was formed by adhering linerboard to the inventive creped paperboard, a structure having burst strength comparable to E-flute was created.

Although various embodiments of the invention have been described using specific terms, devices, and methods, such description is for illustrative purposes only. The words used are words of description rather than of limitation. It is to be understood that changes and variations may be made by those of ordinary skill in the art without departing from the spirit or scope of the present invention, which is set forth in the following claims. In addition, it should be understood that aspects of the various embodiments may be interchanged both in whole or in part. Therefore, the spirit and scope of the appended claims should not be limited to the description of the preferred versions contained therein.

1. A creped paperboard web comprising a first side and a second side, a bonding material disposed on at least the first side, wherein the creped paperboard web has a basis weight greater than about 100 grams per square meter (gsm) and a Burst Strength greater than about 50 pounds per square inch (psi).

2. The creped paperboard web of claim 1 wherein the bonding material comprises a self-crosslinking ethylenevinylacetate latex binder.

3. The creped paperboard web of claim 1 wherein the first side has a Surface Average Roughness (Sa) and a Surface Root Mean Square Roughness (Sq) greater than the second side.

4. The creped paperboard web of claim 3 wherein the difference in the Surface Root Mean Square Roughness (Sq) between the first and second sides is 20 percent.

5. The creped paperboard web of claim 1 wherein the first side has a Surface Root Mean Square Roughness (Sq) greater than about 60 μm and the second has a Surface Root Mean Square Roughness (Sq) less than about 40 μm.

6. The creped paperboard web of claim 1 wherein the first side has a Surface Root Mean Square Roughness (Sq) from about 80 to about 110 μm and the second has a Surface Root Mean Square Roughness (Sq) less than about 30 μm.

7. The creped paperboard web of claim 1 wherein the creped paperboard web has a basis weight from about 120 to about 300 gsm.

8. The creped paperboard web of claim 1 wherein the creped paperboard web has a Burst Strength greater than about 60 psi.

9. The creped paperboard web of claim 1 wherein the creped paperboard web comprises, by weight, from about 2 to about 10 percent of the bonding material.

10. A paperboard structure comprising a first and a second layer, wherein the first layer comprises a linerboard having a basis weight from about 100 to about 300 gsm and the second layer comprises a creped paperboard web having a basis weight from about 100 to about 300 gsm, wherein the paperboard structure has a Burst Strength greater than about 125 psi.

11. The paperboard structure of claim 10 further comprising an adhesive disposed between the linerboard and the creped paperboard web.

12. The paperboard structure of claim 10 wherein the creped paperboard web has a first side, a second textured side and a binder disposed on the first side and the linerboard is adhesively adhered to the second side.

13. The paperboard structure of claim 12 wherein the second textured side has a Surface Root Mean Square Roughness (Sq) greater than about 60 μm and the second has a Surface Root Mean Square Roughness (Sq) less than about 40 μm.

14. The paperboard structure of claim 10 further comprising a third layer consisting of a creped paperboard web having a first side, a second textured side and a binder disposed on the first side.

15. The paperboard structure of claim 14 wherein the linerboard is adhesively adhered to only one of the creped paperboard webs.

16. The paperboard structure of claim 14 wherein the linerboard is adhesively adhered to both the creped paperboard webs.

17. A method of forming a creped paperboard web comprising the steps of:
a. providing a paperboard web having a first side and second side, the web having a basis weight greater than about 100 gsm;
b. applying a bonding material to at least one side of the paperboard web;
c. pressing the paperboard web against the surface of a drying drum; and
d. creping the paperboard web from the dryer drum.

18. The method of claim 17 wherein the bonding material comprises a styrene-butadiene copolymer, a polyvinyl acetate polymer, a vinyl-acetate acrylic copolymer, an ethylene-vinyl chloride copolymer, an ethylene-vinyl chloride-vinyl acetate polymer, an acrylic polyvinyl chloride polymer, an acrylic polymer, or a nitrile polymer.

19. The method of claim 17 wherein the bonding material is applied to the first side of the web in an amount of from about 2 to about 10 percent by weight of the web.

20. The method of claim 17 wherein the bonding material is applied to the first side of the web so as to cover from about 20 to about 30 percent of the surface area of the first side of the web.
